(19) United States
(12) Patent Application Publication
(10) Pub. No.: US 2005/0188069 A1
(43) Pub. Date: Aug. 25, 2005

(54) Zero-configuring IP addresses for peer-to-peer networks

(76) Inventor: Ravikumar Mohandas, San Diego, CA (US)

Correspondence Address: The Law Offices of John C. Scott, LLC;c/o PortfolioIP, P.O. Box 52050, Minneapolis, MN, 55402, US

(21) Appl. No.: 10/749,702

(22) Filed: Dec. 31, 2003

(51) Int. Cl. G06F 15/173

(52) U.S. Cl. 709/223

(57) ABSTRACT

A client device includes DHCP-based functionality for allocating an IP address to the client device for use within an ad-hoc wireless network.

### FIELD OF THE INVENTION

The invention relates generally to communication networks and, more particularly, to peer-to-peer networks.

### BACKGROUND OF THE INVENTION

Many peer-to-peer wireless networking technologies are adopting Internet Protocol (IP) as a means for sending and receiving data between peers. Internet Protocol requires that each individual wireless peer within the network have at least one unique IP address assigned to it. These IP addresses can be assigned to each peer manually. However, such manual configuration of peer devices can be complicated and may require a person with networking expertise to be performed properly. There is a need for techniques and structures that can automate the assignment of IP addresses for use in a peer-to-peer network.

### BRIEF DESCRIPTION OF THE DRAWINGS

FIG. 1 is a diagram illustrating an example ad-hoc wireless network in accordance with an embodiment of the present invention;

FIG. 2 is a block diagram illustrating an example wireless client device in accordance with an embodiment of the present invention; and

FIGS. 3 and 4 are portions of a flowchart illustrating an example method for assigning an IP address to a client device for use in an ad-hoc network in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

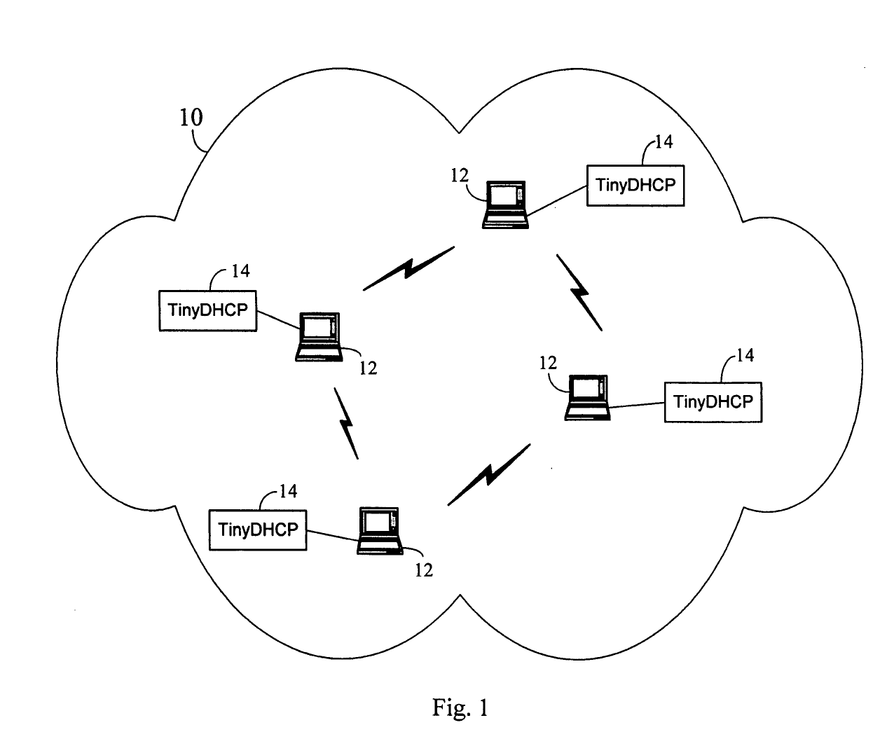

FIG. 1 is a diagram illustrating an example ad-hoc (or peer-to-peer) wireless network 10 in accordance with an embodiment of the present invention. The wireless network 10 may use Internet Protocol (IP) as a means for sending and receiving data between the various nodes of the network. As illustrated in FIG. 1, the ad-hoc wireless network 10 may include a number of wireless client devices 12. Although illustrated with four devices 12, it should appreciated that any number of wireless client devices 12 may be present within the network 10 (i.e., two or more). The wireless client devices 12 may communicate with one another using one or more inter-node wireless links. Each of the client devices 12 may include functionality 14 (that will be referred to herein using the term “tinyDHCP”) for allocating at least one IP address to the associated client device 12 (i.e., to a network interface structure therein) in a manner that is relatively transparent to the corresponding user. That is, the assignment of an IP address will require little or no action on the part of the user. As will be described in greater detail, the tinyDHCP functionality 14 may operate in a manner that emulates functions associated with the well known Dynamic Host Configuration Protocol (DHCP). The client devices 12 may include any form of device that is capable of participating in a wireless network including, for example, a desktop, laptop, palmtop, or tablet computer having wireless networking functionality, a personal digital assistant (PDA) having wireless networking functionality, a cellular telephone or other form of handheld wireless communicator, a pager, and/or others. The client devices 12 may each be configured in accordance with one or more wireless networking standards (e.g., IEEE 802.11 (ANSI/IEEE Std 802.11-1999 Edition) and its supplements, Bluetooth (Specification of the Bluetooth System, Version 1.2, Bluetooth SIG, Inc., November 2003 and related specifications), IRDA (Infrared Data Association Serial Infrared Physical Layer Specification, Version 1.4, May 30, 2001 and related specifications), HomeRF (HomeRF Specification, Revision 2.01, The HomeRF Technical Committee, July, 2002 and related specifications), and/or others).

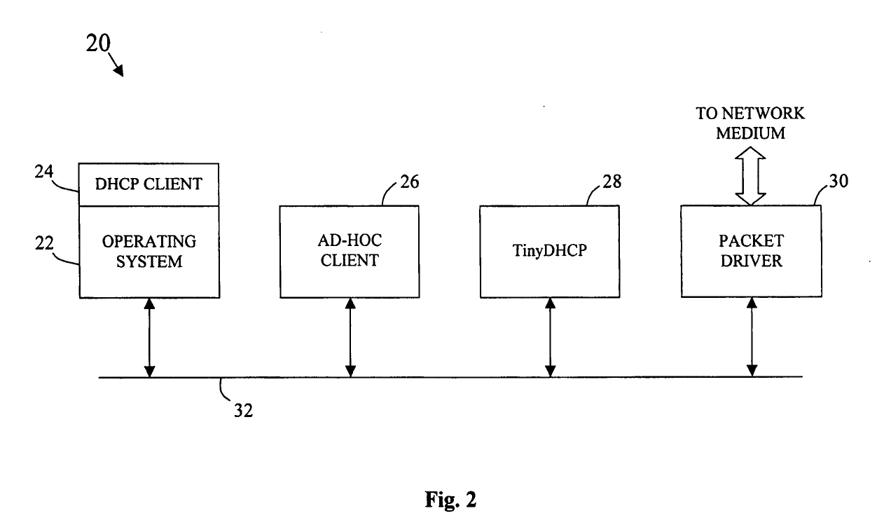

FIG. 2 is a block diagram illustrating an example wireless client device 20 in accordance with an embodiment of the present invention. The wireless client device 20 may be used within the ad-hoc wireless network 10 of FIG. 1 or in other wireless networks. As illustrated in FIG. 2, the wireless client device 20 may include one or more of: an operating system 22, a DHCP client 24, an ad-hoc client 26, a tinyDHCP unit 28, and a packet driver 30. The wireless client device 20 may also include some form of communication medium (or media) 32 to provide communication amongst the various elements. It should be appreciated that the individual blocks illustrated in FIG. 2 may be functional in nature and do not necessarily correspond to discrete hardware elements. For example, in at least one embodiment, two or more of the blocks may be implemented in software within a single (or multiple) digital processing device(s). The digital processing device(s) may include, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others, including combinations of the above. Hardware, software, firmware, or hybrid implementations may be used.

The operating system (OS) 22 is a program within the client device 20 that may be used to, among other things, manage other programs executing within the device 20. Any operating system may be used. The DHCP client 24 is a client service that may or may not be part of the operating system 22 and that is operative for, among other things, issuing requests for the assignment of an IP address for a network interface device within the client device 20. The ad-hoc client 26 is operative for managing ad-hoc network creation and/or setup for the client device 20. The ad-hoc client 26 may provide a user interface (e.g., via OS 22) to allow a user of the client device 20 to provide input regarding ad-hoc network functions (e.g., a request to join or initiate an ad-hoc network, etc.). In at least one embodiment, the ad-hoc client 26 is an application program that executes within the client device 20 with a corresponding application program interface (API). Other implementations are also possible.

The tinyDHCP unit 28 is a client service that is operative for allocating one or more IP addresses to the client device 20 in a manner that is relatively transparent to the associated user. In at least one embodiment, the tinyDHCP unit 28 acts as a proxy DHCP server that communicates with the DHCP client 24 within the client device 20 to process DHCP related requests issued by the DHCP client 24. The tinyDHCP unit 28 may operate, at least in part, in accordance with the DHCP protocol. The tinyDHCP unit 28 may have an associated API that allows user specification of parameters such as IP address range, subnet mask, etc. This API may operate, for example, through the ad-hoc client 26. When user parameter specification is supported, the tinyDHCP unit 28 may default to a pre-configured set of parameters if no new parameters have been specified by the user. In addition to its IP address allocation functions, the tinyDHCP unit 28 may listen to the network medium for DHCP acknowledge (ACK) messages from other nodes and discover the presence of other nodes. When a new node is discovered, the tinyDHCP unit 28 may update an associated database with the new node information (e.g., MAC address, IP address, client identifier (such as machine name or another unique client identifier), etc.). In at least one embodiment, the API of the tinyDHCP unit 28 may provide notification to one or more other applications executing within the client device 20 when certain events occur, such as a new node joining the network and being assigned an IP address, etc.

The packet driver 30 is operative for providing raw access to the wireless network medium for the client device 20 without the use of sockets-based functionality. In the Microsoft® Windows® operating system, for example, the WinSock sockets program is typically used to support input/output requests for an associated network. The WinSock program works well when a corresponding network interface has already been assigned an IP address. The packet driver 30 allows raw access to the network medium when an IP address has not yet been assigned. The packet driver 30 will typically work in conjunction with a wireless network interface card (NIC) or other network interface structure (e.g., integrated wireless networking functionality, etc.). One type of packet driver that may be used with the Microsoft® Windows® OS is the packet capture driver functionality of the WinPcap (Windows Packet Capture) architecture. Other types of packet driver 30 may alternatively be used and will typically depend upon the OS that is being used.

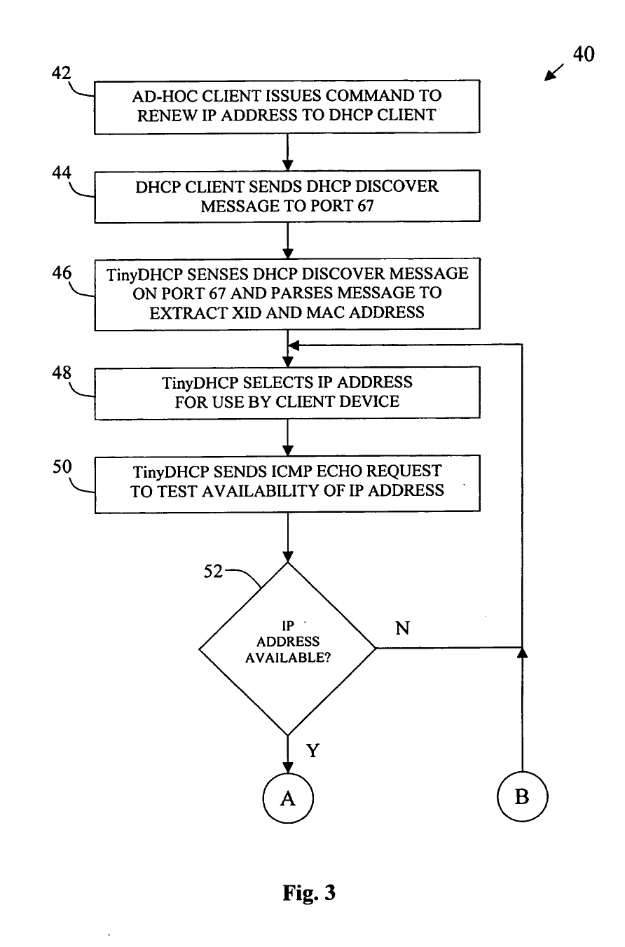

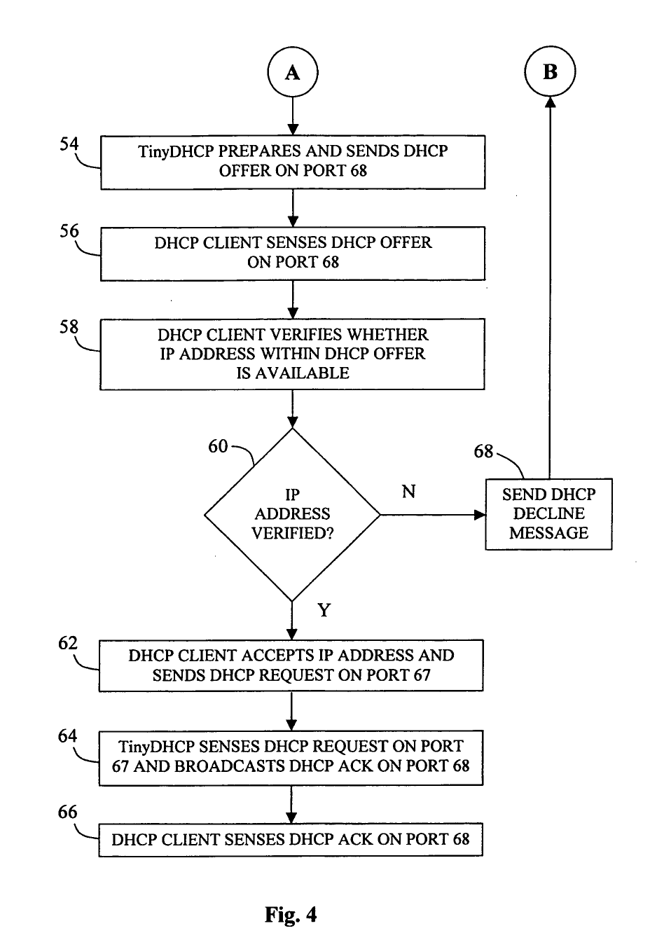

FIGS. 3 and 4 are portions of a flowchart illustrating an example method 40 for assigning an IP address to a client device for use in an ad-hoc network in accordance with an embodiment of the present invention. An ad-hoc client first issues a command to a DHCP client to renew an IP address (block 42). The ad-hoc client may do this in response to a request from a user of the corresponding client device to join an already existing ad-hoc network or to create a new ad-hoc network. The DHCP client may then send a DHCP discover message to a first DHCP port (e.g., port 67) (block 44). A tinyDHCP unit within the client device may be configured to listen to or monitor the first DHCP port. The tinyDHCP unit senses the DHCP discover message on the first DHCP port and parses the message to extract information therefrom (e.g., transaction identification number (XID), medium access control (MAC) address, etc.) (block 46). The tinyDHCP unit may then select an IP address for use by the client device (block 48). The tinyDHCP unit may select the IP address based on factors such as, for example, priorities specified within the DHCP protocol, user specified or default DHCP parameters, parameters within the DHCP discover massage, and/or other factors. The tinyDHCP unit may next send an Internet Control Message Protocol (ICMP) echo request to test the availability of the selected IP address (block 50). Other availability tests may alternatively be used. In at least one embodiment, no availability tests are performed at this point.

If the ICMP echo request results in a determination that the selected IP address is not available (block 52-N), the tinyDHCP unit may select another IP address (i.e., return to block 48). If the ICMP echo request results in a determination that the selected IP address is available (block 52-Y), the tinyDHCP unit may prepare and send a DHCP offer on a second DHCP port (e.g., port 68) (block 54). In at least one embodiment, the tinyDHCP unit unicasts the DHCP offer to the network interface of the specific DHCP client (although other techniques are also possible). The tinyDHCP unit may send the DHCP offer using a packet driver as discussed previously. The DHCP offer will include the selected IP address. The DHCP client within the client device may be configured to listen to or monitor the second DHCP port. The DHCP client senses the DHCP offer on the second DHCP port (block 56). The DHCP client may then verify whether the IP address within the DHCP offer is available (block 58). Any verification technique may be used.

If the IP address is determined to be unavailable (block 60-N), the DHCP client may send a DHCP decline message on the first DHCP port (block 68). The tinyDHCP unit senses the DHCP decline message and decides to select another IP address for the client device (block 48). If the IP address is determined to be available (block 60-Y), the DHCP client accepts the offered IP address and sends a DHCP request (that includes the IP address) on the first DHCP port (block 62). In at least one embodiment, the DHCP client does not attempt to verify the IP address before acceptance (i.e., block 56 flows directly to block 62). The tinyDHCP unit senses the DHCP request on the first DHCP port and broadcasts a DHCP acknowledge (ACK) message (that includes the IP address) on the second DHCP port (block 64). The DHCP client then senses the DHCP ACK message on the second port (block 66) and the IP address assignment is complete. It should be appreciated that the above-described method is merely an example of one possible procedure that may be followed within a client device to assign an IP address for the client device.

In the embodiments described above, the invention is discussed in the context of a wireless peer-to-peer network. It should be appreciated that aspects of the invention may also be implemented in small “wired” networks to effect the assignment of IP addresses to nodes therein.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

1. A client device comprising:
an ad-hoc client to manage connection of said client device to an ad-hoc wireless network;
a DHCP client to send a DHCP discover message in response to a command from said ad-hoc client; and
a tinyDHCP unit to sense said DHCP discover message and allocate an IP address for the client device in response thereto.

2. The client device of claim 1, further comprising:
a packet driver to provide raw access to a wireless network medium for at least the tinyDHCP unit without using sockets functionality.

3. The client device of claim 2, wherein:
said packet driver is a part of a packet capture library.

4. The client device of claim 1, wherein:
said tinyDHCP unit uses dynamic DHCP allocation.

5. The client device of claim 1, wherein:
said DHCP client sends said DHCP discover message to a predetermined port that is monitored by said tinyDHCP unit.

6. The client device of claim 1, wherein:
said tinyDHCP unit tests the availability of said IP address.

7. The client device of claim 6, wherein:
said tinyDHCP unit tests the availability of said IP address by sending an ICMP echo request.

8. The client device of claim 1, wherein:
said tinyDHCP unit sends a DHCP offer that includes the IP address.

9. The client device of claim 8, wherein:
said tinyDHCP unit sends said DHCP offer to a predetermined port that is monitored by said DHCP client.

10. The client device of claim 8, wherein:
said DHCP client senses said DHCP offer and sends a DHCP request based thereon, wherein said DHCP request includes said IP address.

11. The client device of claim 10, wherein:
said DHCP client verifies availability of said IP address before sending said DHCP request.

12. The client device of claim 10, wherein:
said tinyDHCP unit senses said DHCP request and sends a DHCP acknowledge (ACK) message in response thereto.

13. The client device of claim 1, wherein:
said tinyDHCP unit is associated with a user interface to allow a user to specify DHCP parameters.

14. A method for use in connecting a client device to an ad-hoc network, comprising:
sending a DHCP discover message from within the client device;
receiving said DHCP discover message within the client device; and
allocating an IP address to the client device in response to receiving said DHCP discover message, within the client device.

15. The method of claim 14, wherein:
sending includes sending said DHCP discover message to a predetermined port.

16. The method of claim 15, wherein:
receiving includes monitoring said predetermined port and sensing said DHCP discover message on said predetermined port.

17. The method of claim 14, further comprising:
sending a DHCP offer that includes said IP address, after allocating said IP address, from within the client device.

18. The method of claim 17, further comprising:
testing the availability of said IP address before sending said DHCP offer.

19. The method of claim 17, wherein:
sending a DHCP offer includes causing a packet driver to send said DHCP offer on a wireless network medium.

20. The method of claim 19, wherein:
said packet driver sends said DHCP offer on said wireless network medium without the use of sockets functionality.

21. The method of claim 17, further comprising:
receiving said DHCP offer within the client device; and
sending, after receiving said DHCP offer, a DHCP request that includes said IP address from within the client device.

22. The method of claim 21, further comprising:
verifying that the IP address within the DHCP offer is available before sending said DHCP request.

23. The method of claim 21, further comprising:
receiving said DHCP request within the client device; and
sending, after receiving said DHCP request, a DHCP acknowledge (ACK) message from within the client device.

24. The method of claim 23, further comprising:
receiving said DHCP ACK message within the client device.

25. The method of claim 14, wherein:
allocating includes using dynamic DHCP allocation.

26. An article comprising storage media having instructions stored thereon that, when executed by a computing platform, result in:
sending a DHCP discover message from within a client device;
receiving said DHCP discover message within the client device; and
allocating an IP address to the client device in response to receiving said DHCP discover message, from within the client device.

27. The article of claim 26, wherein:
sending includes sending said DHCP discover message to a predetermined port.

28. The article of claim 27, wherein:
receiving includes monitoring said predetermined port and sensing said DHCP discover message on said predetermined port.

29. The article of claim 26, further comprising:
sending a DHCP offer that includes said IP address, after allocating said IP address, from within the client device.

30. A client device comprising:
a wireless network interface card (NIC) to provide an interface to a wireless network medium;
an ad-hoc client to manage connection of said client device to an ad-hoc wireless network;
a DHCP client to send a DHCP discover message in response to a command from said ad-hoc client; and
a tinyDHCP unit to sense said DHCP discover message and allocate an IP address for the client device in response thereto.

31. The client device of claim 30, wherein:
said wireless NIC is configured in accordance with the IEEE 802.11 wireless networking standard.

32. The client device of claim 30, further comprising:
a packet driver to provide raw access to said wireless network medium for the tinyDHCP unit without using sockets functionality.

33. The client device of claim 32, wherein:
said packet driver is part of a packet capture library.

34. The client device of claim 30, wherein:
said tinyDHCP unit uses dynamic DHCP allocation.
